(19) United States
(12) Patent Application Publication
(10) Pub. No.: US 2026/0296483 A1
(43) Pub. Date: Oct. 1, 2026

(54) LIDAR-BASED SURFACE VIBRATION DETECTION SYSTEM FOR AUDIO WAVE ANALYSIS

(71) Applicant: Torc Robotics, Inc., Blacksburg, VA (US)

(72) Inventors: Sebastian Dingler, Stuttgart (DE); Xholjon Dede, Esslingen am Neckar (DE); Adam Schneider, Christiansburg, VA (US); Gerardas Skeberdis, Hickory Hills, IL (US); Siegwart Bogatscher, Leonberg (DE); Paul Birth, Esslingen, Baden-Wurttemberg (DE)

(21) Appl. No.: 19/095,791

(22) Filed: Mar. 31, 2025

(51) Int. Cl. B60W 60/00; G01H 9/00; H04N 23/61; H04N 23/67

(52) U.S. Cl. CPC B60W 60/001; G01H 9/00; H04N 23/61; H04N 23/671; B60W 2420/403

(57) ABSTRACT

A system including at least one memory and at least one processor coupled to the at least one memory is disclosed. The at least one processor is configured to: receive, from a camera mounted on the autonomous vehicle, camera data; receive, from a sensor mounted on the autonomous vehicle, sensor data; identify, based on the camera data, a surface in the environment of the autonomous vehicle; and process a subset of the sensor data associated with the surface to determine an audio signal based on vibration of the surface.

### TECHNICAL FIELD

The field of the disclosure relates generally to detecting sound in an environment of an autonomous vehicle and, more specifically, using LIDAR-based surface vibration to detect audio waves from vibrational surfaces.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

In some instances, it can be difficult for existing autonomous vehicle sensing systems to detect and analyze audio waves in the environment of the autonomous vehicle. For example, audio data can be noisy, or an autonomous vehicle may not be equipped with a microphone or other audio sensor. The ability to accurately detect certain audio waves can be useful for navigation and decision-making (e.g., if a siren is detected in the environment of the autonomous vehicle).

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system including at least one memory configured to store instructions and at least one processor coupled to the at least one memory is disclosed. The at least one processor is configured to execute the instructions to perform operations including:
(i) receiving, from a camera mounted on an autonomous vehicle, camera data; (ii) receiving, from a sensor mounted on the autonomous vehicle, sensor data; (iii) identifying, based on the camera data, a surface in the environment of the autonomous vehicle; and (iv) processing a subset of the sensor data associated with the surface to determine an audio signal based on vibration of the surface.

In another aspect, a computer-implemented method is disclosed. The computer-implemented method includes: (i) receiving, from a camera mounted on an autonomous vehicle, camera data; (ii) receiving, from a sensor mounted on the autonomous vehicle, sensor data; (iii) identifying, based on the camera data, a surface in the environment of the autonomous vehicle; and (iv) processing a subset of the sensor data associated with the surface to determine an audio signal based on vibration of the surface.

In yet another aspect, a non-transitory computer-readable storage medium, the non-transitory computer-readable storage medium including instructions is disclosed. When executed by a computer, the instructions configure the computer to: (i) receive, from a camera mounted on an autonomous vehicle, camera data; (ii) receive, from a sensor mounted on the autonomous vehicle, sensor data; (iii) identify, based on the camera data, a surface in the environment of the autonomous vehicle; and (iv) process a subset of the sensor data associated with the surface to determine an audio signal based on vibration of the surface.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an illustration of an autonomous vehicle in an environment;

FIG. 5 is an illustration of a process for detecting an audio signal based on sensor data; and

FIG. 6 is a flow chart of a method for implementing a navigational action based, at least in part, on an audio signal.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Ego vehicle: Ego vehicle, as described herein, refers to a vehicle equipped with sensors to perceive the environment surrounding the ego vehicle. The sensors may include one or more of: one or more camera sensors, one or more radio detection and ranging (RADAR) sensors, one or more light detection and ranging (LiDAR) sensors, one or more inertial measurement unit (IMU) sensors, etc. The ego vehicle may be an autonomous vehicle, a semi-autonomous vehicle, or a non-autonomous vehicle.

RTK-GNSS: Real-Time Kinematic (RTK) and Global Navigation Satellite System (GNSS) positioning are techniques for obtaining position information from satellite-based systems. RTK and GNSS, however, differ in terms of accuracy and methodology. RTK provides positional information that is precise in the order of centimeters based upon real-time correction signals received from a network of fixed reference stations with known positions (also referenced herein as rovers). GNSS, on the other hand, provides positional information that is precise in the order of several meters based upon time-of-flight computations of signals received from satellites that are affected by one or more of: satellite clock errors, atmospheric delays, or multipath errors.

Navigational decision-making for an ego vehicle can be based predominantly on data associated with objects in the FOV of the ego vehicle. For example, camera and sensor (e.g., LiDAR or RADAR) data can be used to detect the locations and trajectories of objects (e.g., vehicles, pedestrians, road markers, etc.) in the FOV of the ego vehicle. Navigational decisions can be made based on this information. However, navigational decision-making can be improved by increasing the amount of data from which a navigational decision can be made. As an example, audio signals in the environment of the ego vehicle can provide important information that should be accounted for in navigational decision-making.

Audio signals in the environment of the ego vehicle can indicate, for example, the presence or the approach of emergency vehicles and personnel. In other examples, audio signals can be associated with emergency or official personnel providing verbal instructions for vehicles to navigate a particular situation (e.g., traffic at an intersection, an area around an accident or construction area, etc.). It is important for the ego vehicle to detect and analyze these audio signals to make navigational decisions to avoid road hazards, comply with law enforcement or emergency personnel instructions, or comply with traffic laws (e.g., by pulling over and stopping to allow an emergency vehicle to pass).

Disclosed systems and methods can facilitate detection and analysis of audio signals in an environment of the ego vehicle by leveraging camera and sensor data for surface vibration detection. The disclosed systems and methods can be used with existing camera and sensor systems on autonomous vehicles to sense audio signals based on vibrations detected on surfaces.

As an example, a camera mounted on an autonomous vehicle can collect camera data (e.g., images of the FOV of the ego vehicle), which can be analyzed by a processor of the ego vehicle. The camera data can be analyzed to identify surfaces in the FOV of the ego vehicle that are capable of vibrating. A surface can be an audio emitting or audio reflective surface. For example, a surface can be a flat or smooth, rigid surface, such as a vehicle window or road sign. In another example, a surface can be a membrane (e.g., a membrane of a speaker). Analysis of the camera data can identify these surfaces, or areas of an image that may contain such surfaces, based on image analysis to identify and recognize objects in the FOV of the ego vehicle.

Based on the identification of a surface (e.g., a vibrating surface or a surface capable of reflecting audio waves), the processor can filter sensor data (e.g., collected by a LiDAR sensor) to sensor data associated with the region of the surface. In another example, the processor can cause a sensor (e.g., a LiDAR sensor) to focus on an area of the detected surface and record sensor data for that area. The sensor data can then be analyzed to identify a vibration of the surface. For example, analysis of time-series sensor data can detect vibrations of the surface. The processor can analyze the timing and magnitude of the vibrations to generate an audio wave associated with the vibrations. For example, the vibrations can be caused by an audio wave in the environment of the surface. The vibrations of the surface (e.g., magnitude of the vibrations, vibration spacing, and/or vibration timing) can be used to determine the frequency and amplitude of the audio wave that is causing the vibrations.

Based on the detection of the audio wave, the processor of the autonomous vehicle can use the presence and properties of the audio wave in its decision-making process. For example, the processor of the autonomous vehicle can determine whether the audio wave corresponds with an emergency vehicle siren (e.g., based on wave magnitude and frequency compared with the average magnitude and frequency of an audio wave associated with a siren). In another example, the processor can trigger an audio detection system (e.g., a microphone) to collect audio data from the environment of the autonomous vehicle. The audio data can then be filtered based on characteristics of the audio wave detected from the vibrations.

Data associated with the audio wave can be used to determine a type of audio wave (e.g., whether the audio wave is likely to correspond to a siren in the environment of the vehicle), which can be used to implement a navigational action. For example, if the detected audio wave has properties corresponding to its source being a siren, the processor can cause the autonomous vehicle to reduce speed and/or to pull over. In another example, the processor can focus the camera and/or sensor system on an estimated source of the audio wave (e.g., an emergency vehicle) to determine data (e.g., speed, trajectory, directional signals, etc.) of the emergency vehicle that can be used in the navigational decision-making process.

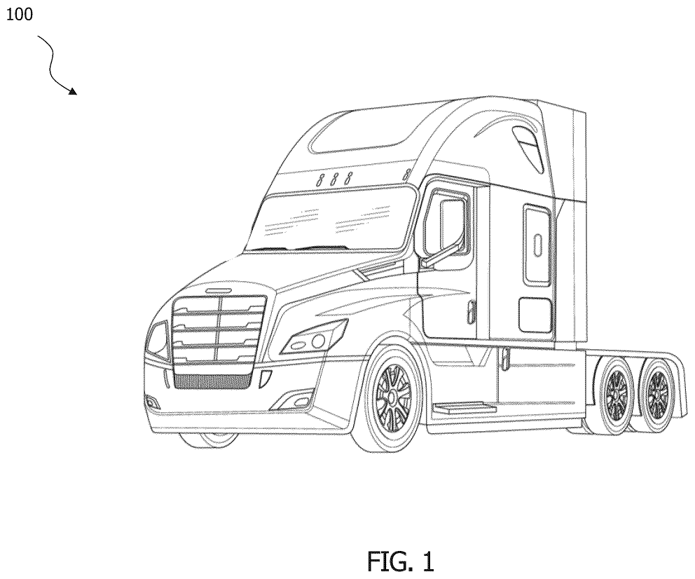

FIG. 1 illustrates a vehicle 100, such as a truck that may be conventionally connected to a single or tandem trailer to transport the trailer (not shown) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

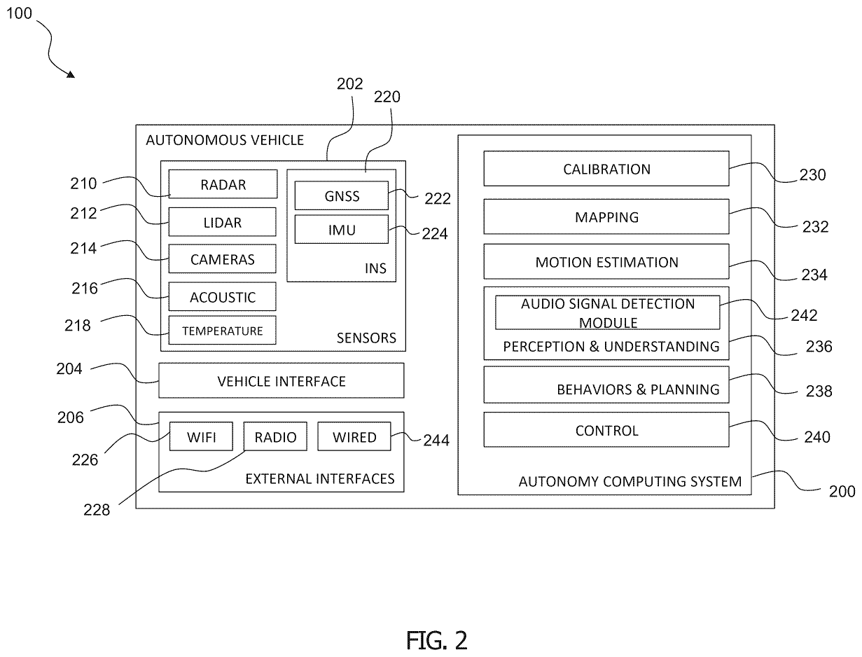

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an audio signal detection module 242. Audio signal detection module 242, for example, may be embodied within another module, such as behaviors and planning module 238, or separately. In some examples, as shown in FIG. 2, audio signal detection module 242 may be embodied within perception and understanding module 236. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Audio signal detection module 242 may access camera data from cameras 214 and sensor data from sensors mounted on autonomous vehicle 100 (e.g., LiDAR 212 and/or RADAR 210). Audio signal detection module 242 can analyze the camera data to identify a surface in one or more images of the camera data. Based on the location of the surface, audio signal detection module 242 can identify and analyze sensor data associated with the surface, or can focus a sensor (e.g., LiDAR 212) on the surface to record sensor data associated with the surface.

Audio signal detection module 242 can analyze the sensor data to detect and measure vibrations in the surface. For example, sensor data can be time-series data representative of the environment of autonomous vehicle 100, including data associated with the locations of objects (including the surface) within the environment of autonomous vehicle 100 at a given time. Accordingly, by analyzing the location of a point on the surface at a first time, and the location of the point on the surface at one or more subsequent times, audio signal detection module 242 can detect vibrations of the surface. The vibrations can be analyzed to identify an audio wave based on measurements associated with the vibrations.

Based on the presence of an audio wave in the environment of autonomous vehicle 100 (e.g., as determined by audio signal detection module 242), behaviors and planning module 238 can determine a navigational plan for autonomous vehicle 100 to be implemented by control module 240. For example, based on the presence and type of audio wave, behavior and planning module 238 can determine a navigational plan for autonomous vehicle 100 to maneuver to comply with local law regarding emergency vehicles or can initiate additional detection using acoustic sensors 216.

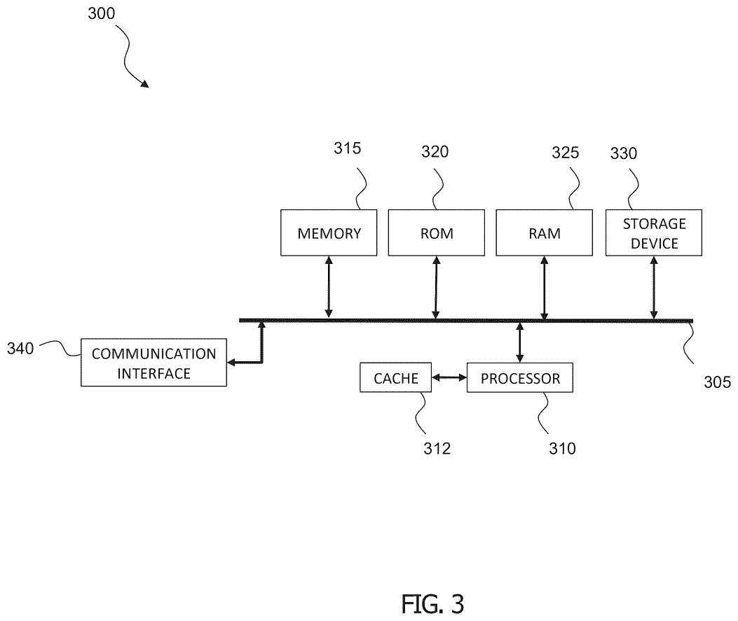

FIG. 3 illustrates an example computing system 300 that can implement various techniques, processes, functions, or methods described herein. The components of computing system 300 are shown in electrical communication with each other using a connection 305, such as a bus. The example computing system 300 includes a processing unit (CPU or processor) 810 and a computing device connection 305 that couples various computing device components, including computing device memory 315, such as a read only memory (ROM) 820 and a random access memory (RAM) 825, and communication interface 340 to processor 310.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

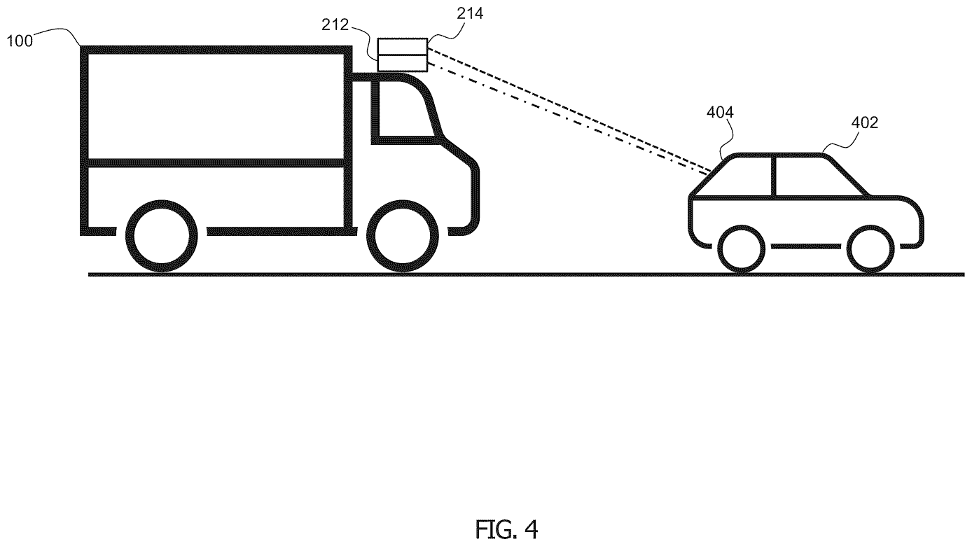

FIG. 4 is an illustration of autonomous vehicle 100, shown in FIGS. 1 and 2, in an environment including a vehicle 402 in accordance with some embodiments of the present disclosure. Autonomous vehicle 100 can include a mounted camera 214 and LiDAR 212.

During operation, camera 214 can capture images (e.g., camera data) of the environment of autonomous vehicle 100, which can include objects in the environment of autonomous vehicle 100, such as vehicle 402. Audio signal processing module 242 can access an image and analyze the image to identify a relatively flat surface. For example, audio signal detection module 242 can identify objects in a camera image or frame taken at a first time and can determine an area of the image (and therefore an area within the environment of autonomous vehicle 100) that corresponds to a vibrating surface, such as a rear window 404 of vehicle 402. Other exemplary relatively flat surfaces can include road or highway signage, truck siding or doors, vehicle panels, and the like.

Based on the presence of the flat surface (e.g., rear window 404) in a camera image, audio signal detection module 242 can identify sensor data collected by LiDAR 212 at the first time that is associated with the area of the environment containing rear window 404. In some examples, audio detection module 242 can identify and track rear window 404 in the environment of autonomous vehicle 100, to access sensor data associated with rear window 404 at the first time and at one or more subsequent times. In another example, based on detection of the flat surface (e.g., rear window 404), audio signal detection module 242 can cause LiDAR 212 to focus on rear window 404 for a predetermined time period. In some examples, by focusing on rear window 404, LiDAR 216 can collect higher resolution sensor data of the FOV associated with the flat surface.

Audio signal detection module 242 can analyze the sensor data collected during the time period to identify vibrations in the surface (e.g., rear window 404). For example, audio signal detection module 242 can measure an amount of displacement of one or more points on the surface over the period of time and, based on the displacements, can determine an audio wave associated with the vibrations in the surface. For example, audio detection module 242 can use one or more algorithms associated with laser Doppler vibrometry (LDV).

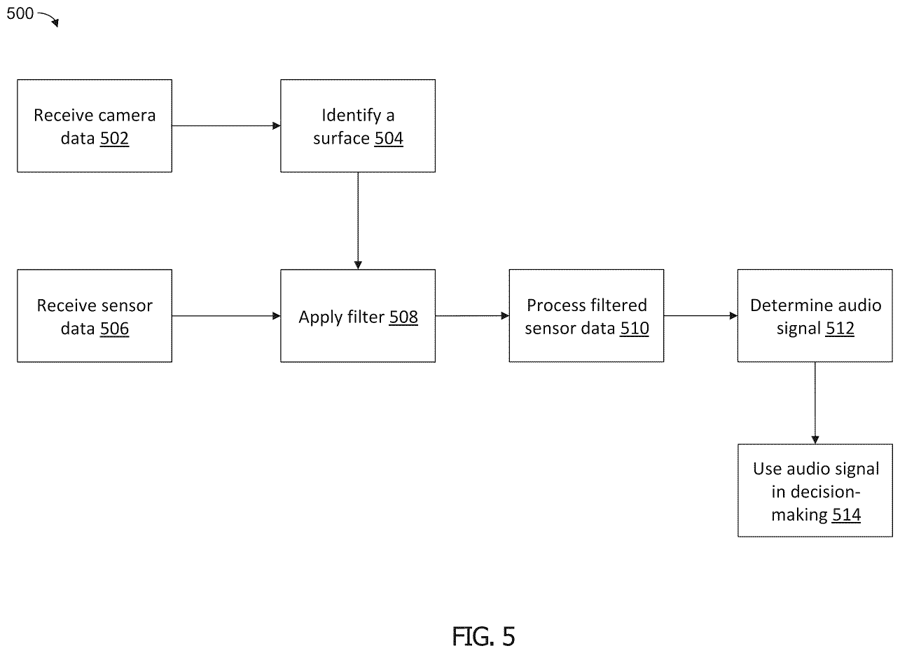

FIG. 5 is an illustration of a process 500 for controlling autonomous vehicle 100 based, at least in part, on detection of an audio wave from surface vibrations of an object in the environment of autonomous vehicle 100.

Process 500 can include receiving 502, by a processor (e.g., processor 310) camera data. The camera data can be camera images collected by the camera 214 during the operation of autonomous vehicle 100 of the environment of autonomous vehicle 100. Camera images can include objects in the FOV of camera 214, which can include other vehicles, pedestrians, signage, and the like.

Process 500 can include, identifying 504, by the processor (e.g., processor 310) a surface in the camera data (e.g., a surface capable of vibrating to emit or reflect audio waves). For example, the processor can analyze, using one or more image processing techniques, a camera image or camera data associated with a first time. Using image processing techniques, the processor can identify objects in the FOV of camera 214 and can determine characteristics of an object. In some examples, the processor can analyze multiple camera images taken at different times to identify a surface (e.g., a surface capable of emitting or reflecting audio waves). A surface can refer to a relatively flat, rigid surface such as a window, vehicle body panel, or signage. The surface can be detected, in some examples, using object recognition based on analysis of an image to identify portions of known objects in the FOV of camera 214 that are likely to be surfaces capable of vibrating to emit or reflect audio waves.

At roughly the same time, or in tandem, process 500 can include receiving 506, by the processor (e.g., processor 310), sensor data. Sensor data can be data collected by LiDAR 212 or RADAR 210, or by another sensor mounted on autonomous vehicle 100. The sensor data can, for example, form a point cloud indicative of distances of objects in the environment of autonomous vehicle 100 from autonomous vehicle 100. In some examples, analysis of the sensor data collected at multiple times (e.g., a first time and a subsequent second time) can be used to determine the speed, trajectory, and other characteristics of objects in the FOV of the sensor.

Process 500 can include applying 508, by the processor (e.g., processor 310), a filter to the sensor data based on the camera data. For example, the processor can, at block 504, identify a surface associated with a particular object in the environment of autonomous vehicle 100. The processor can filter the sensor data to data associated with the surface, for example, by overlaying a camera image with sensor data to correlate the sensor data with the camera data to determine the subset of sensor data associated with the surface. In another example, the processor can cause the sensor (e.g., LiDAR 212 or RADAR 210) to focus on the surface and to collect data for a predetermined time period while focused on the surface.

Process 500 can include processing 510, by the processor (e.g., processor 310), the filtered sensor data. Processing the filtered sensor data can include, for example, detecting displacements in the surface from an origin position of the surface to detect vibrations in the surface. In some examples, detecting the displacements can include accounting for movement in the surface along a trajectory (e.g., based on characteristics associated with the object of the reflecting surface). For example, based on a trajectory and speed of a vehicle containing the surface (e.g., a rear window), the processor can determine a next estimated position of the rear window. Based on measurement of deviation from the estimated next position, the processor can determine a vibration-associated displacement of the surface. In some examples, the displacement of a number of points on the surface can be measured. Based on the displacements of each of the number of points, the processor can identify a pattern of vibrations in the surface.

Process 500 can include determining 512, by the processor (e.g., processor 310), an audio signal based on the detected vibration. For example, the processor can use one or more LDV techniques to calculate an audio wave that corresponds to the vibrational pattern. For example, an amplitude, wavelength, and frequency of the audio wave can be calculated based on the distance and magnitudes of troughs and peaks of the vibrational pattern determined from the sensor data at block 510.

Process 500 can include using 514, by the processor (e.g., processor 310), the audio signal in decision-making. For example, the processor can analyze the audio signal to determine a frequency of the audio signal. The processor can compare the determined frequency with one or more frequencies associated with emergency vehicle sirens or signals. If the audio signal matches an emergency vehicle siren within a predetermined threshold, the processor can cause autonomous vehicle 100 to take a navigational action such as pulling over, reducing speed, stopping, or another action based on local traffic laws. In another example, the presence of an audio signal corresponding to a certain decibel level can trigger acoustic sensor 216 to perform language processing on recorded audio (e.g., to determine if emergency personnel are providing verbal instructions) such that a navigational action taken by autonomous vehicle 100 can be based on and can conform to the instructions. In another example, based on the detection of an audio signal and on the simultaneous detection of a particular type of object (e.g., an emergency vehicle) in the camera data, the processor may determine a navigational action. This can help the processor determine, for example, whether an emergency vehicle in the environment of autonomous vehicle has its siren on or is broadcasting verbal instructions over a loud speaker.

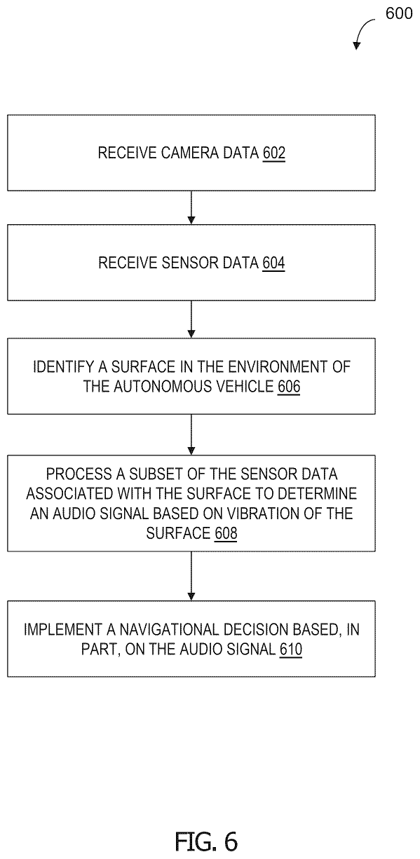

FIG. 6 is a flow chart of a method 600 for implementing a navigational decision based, at least in part, on a detected audio signal. Method 600 may be performed by autonomy computing system 200 shown in FIG. 2 or a computing device shown in FIG. 3, which may be a server (or an application server) located at mission control. Method 600 may be performed by processor 310 (e.g., by audio signal detection module 242) based upon sensor data of sensors 202.

Method 600 can include, receiving 602, by audio signal detection module 242, camera data from a camera (e.g., a camera 214) mounted on the autonomous vehicle 100.

Method 600 can include, receiving 604, by audio signal detection module 242, sensor data from a sensor (e.g., LiDAR 212 or another sensor 202) mounted on autonomous vehicle 100. The sensor data can be point cloud data associated with a particular time or associated with a predetermined period of time. The camera data can include a set of sequential frames and the sensor data can include a corresponding set of sequential frames.

Method 600 can include, identifying 606, by audio signal detection module 242, a surface (e.g., a vibrating surface or surface capable of emitting or reflecting audio waves) in the environment of autonomous vehicle 100. For example, based on image analysis, audio signal detection module 242 can identify an object having at least one relatively flat surface.

Method 600 can include processing 608, by audio signal detection module 242, a subset of the sensor data associated with the surface to determine an audio signal based on vibration of the surface. For example, sensor data associated with the surface can be analyzed to identify displacement of one or more points on the surface with respect to a starting point. Based on this information and on one or more techniques, such as LDV, audio signal detection module 242 can determine an audio signal.

Method 600 can include implementing 610, by audio signal detection module 242 or another module of autonomy computing system 200, a navigational decision based, in part, on the audio signal. For example, a navigational action could be to cause autonomous vehicle 100 to comply with verbal instructions or to comply with local law regarding emergency vehicles.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least improving safety of an autonomous vehicle by providing accurate training data to train machine learning models for controlling the autonomous vehicle. The improved quality of the training data can result in improved machine learning model outcomes by increasing the prediction accuracy of the machine learning model.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system comprising:
at least one memory configured to store instructions; and
at least one processor coupled to the at least one memory and configured to execute the instructions to perform operations comprising:
receiving, from a camera mounted on an autonomous vehicle, camera data;
receiving, from a sensor mounted on the autonomous vehicle, sensor data;
identifying, based on the camera data, a surface in the environment of the autonomous vehicle; and
processing a subset of the sensor data associated with the surface to determine an audio signal based on vibration of the surface.

2. The system of claim 1, wherein the operations further comprise:
implementing, by the autonomous vehicle, a navigational decision based on the audio signal being present in the environment of the autonomous vehicle.

3. The system of claim 1, wherein the operations further comprise:
focusing the sensor on the surface; and
collecting, by the sensor, the subset of the sensor data.

4. The system of claim 1, wherein the subset of the sensor data is time-series data.

5. The system of claim 1, wherein the operations further comprise:
filtering the sensor data to generate the subset of the sensor data.

6. The system of claim 1, wherein the operations further comprise:
determining an approximate location of a source of the audio signal based on the camera data and the sensor data.

7. The system of claim 1, wherein identifying the surface in the environment of the autonomous vehicle comprises analyzing the camera data to identify a door panel or window of a vehicle or a surface of a sign.

8. A computer-implemented method comprising:
receiving, from a camera mounted on an autonomous vehicle, camera data;
receiving, from a sensor mounted on the autonomous vehicle, sensor data;
identifying, based on the camera data, a surface in the environment of the autonomous vehicle; and
processing a subset of the sensor data associated with the surface to determine an audio signal based on vibration of the surface.

9. The method of claim 8, further comprising:
implementing, by the autonomous vehicle, a navigational decision based on the audio signal being present in the environment of the autonomous vehicle.

10. The method of claim 8, further comprising:
focusing the sensor on the surface; and
collecting, by the sensor, the subset of the sensor data.

11. The method of claim 8, further comprising:
filtering the sensor data to generate the subset of the sensor data.

12. The method of claim 8, further comprising:
determining an approximate location of a source of the audio signal based on the camera data and the sensor data.

13. The method of claim 8, wherein identifying the surface in the environment of the autonomous vehicle comprises analyzing the camera data to identify a door panel or window of a vehicle or a surface of a sign.

14. An autonomous vehicle comprising:
a camera configured to generate camera data;
a sensor configured to generate sensor data;
at least one memory configured to store computer executable instructions; and
at least one processor coupled to the camera, the sensor, and the at least one memory, and configured to execute the computer executable instructions to:
receive, from the camera mounted on the autonomous vehicle, camera data;
receive, from the sensor mounted on the autonomous vehicle, sensor data;
identify, based on the camera data, a surface in the environment of the autonomous vehicle; and
process a subset of the sensor data associated with the surface to determine an audio signal based on vibration of the surface.

15. The autonomous vehicle of claim 14, wherein the at least one processor is further configured to execute the computer executable instructions to:
implement, by the autonomous vehicle, a navigational decision based on the audio signal being present in the environment of the autonomous vehicle.

16. The autonomous vehicle of claim 14, wherein the at least one processor is further configured to execute the computer executable instructions to:
focus the sensor on the surface; and
collect, by the sensor, the subset of the sensor data.

17. The autonomous vehicle of claim 14, wherein the subset of the sensor data is time-series data.

18. The autonomous vehicle of claim 14, the at least one processor is further configured to execute the computer executable instructions to:
filter the sensor data to generate the subset of the sensor data.

19. The autonomous vehicle of claim 14, the at least one processor is further configured to execute the computer executable instructions to:
determine an approximate location of a source of the audio signal based on the camera data and the sensor data.

20. The autonomous vehicle of claim 14, wherein identifying the surface in the environment of the autonomous vehicle comprises analyzing the camera data to identify a door panel or window of a vehicle or a surface of a sign.
